(19) United States
(12) Patent Application Publication
(10) Pub. No.: US 2017/0270492 A1
(43) Pub. Date: Sep. 21, 2017

(54) SYSTEMS, METHODS AND ARCHITECTURE FOR A FUNCTIONAL, INTERNATIONAL BITCOIN BANK

(71) Applicant: SENDLATER, INC., Woodstock, VT (US)

(72) Inventors: John J. Donovan, Hamilton, MA (US); Paul D. Parisi, Boxford, MA (US); Sahil S. Sachdev, Cambridge, MA (US); Joshua Paredes, Salem, MA (US)

(21) Appl. No.: 15/366,860

(22) Filed: Dec. 1, 2016

Related U.S. Application Data
(60) Provisional application No. 62/261,546, filed on Dec. 1, 2015.

(51) Int. Cl. G06Q 20/06; G06Q 20/40; G06Q 20/10

(52) U.S. Cl. CPC G06Q 20/0655; G06Q 20/108; G06Q 20/40

(57) ABSTRACT

A Bitcoin bank is described for securing Bitcoins physically and electronically from hacking, denial of service, and spoofing. Hardware of the invention allows various Bitcoin security machines that are disparate to seamlessly integrate as one cohesive offering. Systems and methods further relate to Bitcoin currency conversion, online and offline storage, arbitrage, and security systems to prevent Bitcoins being used in terrorism or other illegal activities.

### CROSS-REFERENCE TO RELATED APPLICATIONS

This application claims priority to U.S. Provisional patent application Ser. No. 62/261,546, filed Dec. 1, 2015, the contents of which are herein incorporated by reference in their entirety.

### FIELD OF THE INVENTION

The present invention relates to a functional international Bitcoin bank.

### BACKGROUND

A disruption in the financial sector has occurred, a new currency has emerged—Bitcoin. Advantages include: a finite number of coins, no government generates them, there is a record of every transaction (Blockchain), and it is now recognized as a global digital currency. Europe, for example, has reclassified Bitcoin from a commodity to a currency (Sam Schechner, Wall Street Journal, EU Rules Bitcoin Is a Currency, Not a Commodity-Virtually, Oct. 22, 2015) It is anticipated that there will be 12 million Bitcoin wallets by the end of 2015 (Coindesk, State of Bitcoin 2015: Ecosystem Grows Despite Price Decline, Jan. 17, 2015)

For the consumer, there is no machine, hardware that encompasses the ability for the customer to purchase Bitcoins, store them, exchange them for local currency, document them, protection against theft and provide traditional banking services of savings accounts, checking accounts, credit cards, and loans, and deal with the currency fluctuation of Bitcoins.

For example: If a consumer holds Bitcoins, how does he securely save them? How does hedge against the fluctuation in their values? How does he seamlessly and easily convert them into various currencies? How does he buy additional Bitcoin?

Some of these services are provided by individual companies but hardware, and websites are disparate systems, without seamless integration from a customer's point of view.

At present there is not encompassing security mechanism that can secure, the customer's funds, and, in today's society, a threat to all of us—terrorism. There is no mechanism for effectively detecting, and mitigating possible use of Bitcoins for terrorism, funding other illegal activities such as drug trafficking, human trafficking, etc.

Terrorism is all prevalent. The recent Paris attacks, attack in Malaysia, and more have to be funded somehow. A key to stopping such attack is to prevent the funding. These inventions will mitigate such funding through the use of Bitcoins.

Illegal activities such and drug and human trafficking, unfortunately, occur with great frequency in today's age. These activities need to be funded in order to operate. These inventions will mitigate illegal activities such drug trafficking, human trafficking from using Bitcoins to fund their operations. See Applications WO2012172117, U.S. Pat. No. 9,135,787, CN104463001, US20130166455, US20150046337, US20150227897, US20130238478, and US2013024623, the contents of each of which are hereby incorporated by reference.

### SUMMARY

Aspects of the invention include systems and methods using a newly invented hardware architecture for securing Bitcoins physically and electronically against hacking, denial of service and spoofing. Other Aspects of the invention include systems and methods, machines, and hardware for hedging fluctuations in values using social media and other external sources and devices and using weighted meta data and meta data on the meta data. Aspects include systems and methods, and hardware for seamlessly converting Bitcoins into different currencies in a secure and authenticated way. Systems and methods, and hardware for procuring Bitcoins for the bank in a secure, authenticated and efficient way are described. Systems and methods, and hardware for storing Bitcoins for the bank in a secure authenticated and efficient way. Either by using hardware storage online or off-line (Cold Storage) augmented with the invented device.

In certain aspects the invention includes systems, methods and hardware of arbitrage that includes social media data, tip data, news, and data from other devices, as well as associated meta-data. Systems, methods, and hardware are described in certain aspects that mitigate use of Bitcoins for terrorism, and illegal activities such as drug trafficking and human trafficking, using weighted meta data and meta data on the meta data, for alerting appropriate authorities. Aspects include systems, methods, and hardware for procuring Bitcoins for the bank in a secure authenticated, efficient, and authenticated way. The hardware authenticates with the use of meta data and meta meta data, or associated with the exchanges in mining.

### BRIEF DESCRIPTION OF THE DRAWINGS

FIG. 1 shows architecture of a Bitcoin bank

FIG. 2 shows volatility in the Bitcoin market.

FIG. 3 shows a Bitcoin flowchain explaining cash conversion and Bitcoin storage.

FIG. 4 shows Bitcoin service security.

FIG. 5 shows a Cold Storage solution.

FIG. 6 shows Bitcoin to currency conversion.

### DETAILED DESCRIPTION

Architecture

Forming a bank based on services offered by different entities and aggregating them under one linked entity. This invention is hardware that would provide customers the ability to streamline their bitcoin banking needs. Beginning with traditional banking services such as saving accounts in secure, online and offline storage to checking accounts with active bitcoin debit cards.

This hardware architecture virtualizes every entity so that to the customer each entity is seamlessly integrated. The invention entails hardware that surrounds these entities with systems and methods that can mimic a customer accessing each of the functional entities.

Equation 1 below describes the surround function. Where f is a function of access, and access is the services the customer obtains that are under the architecture of the bank. f_{access} access allows the customer to take advantage of all the services that the bank provides in one simple customer interface. Xₙ represents the entities under the architecture of the bank.

access=f_{access}[X₁∩X₂∩X₃∩ . . . Xₙ] Equation 1
Xₙ=entity under architecture
   access=services to user

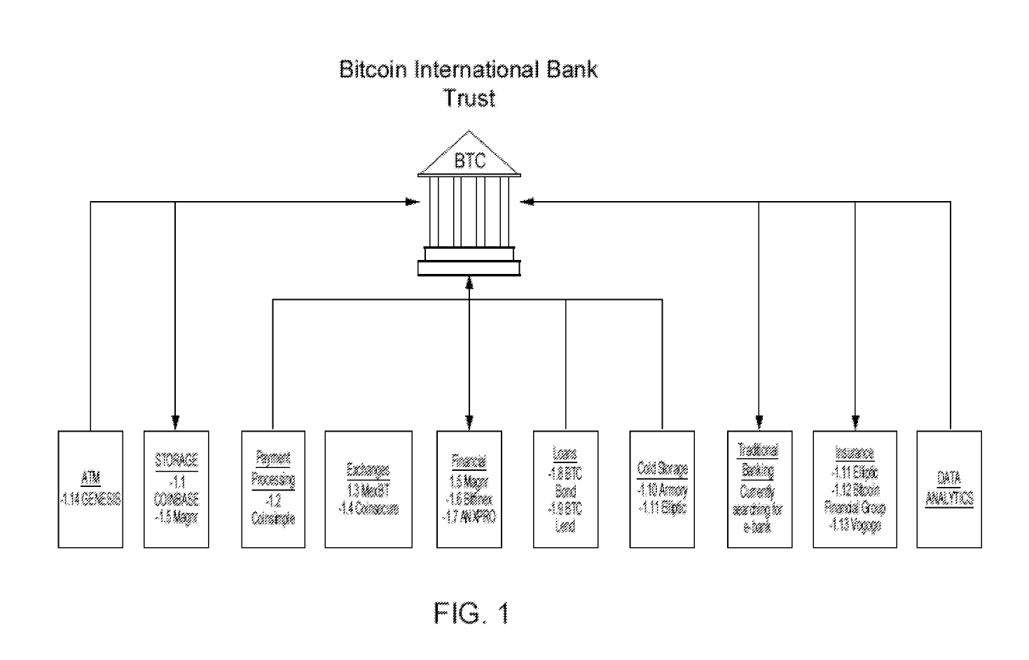

FIG. 1 provides the physical architecture of the bank, where each box represents a machine that performs a specific function for the customer. The technology innovation in this patent is hardware that will allow all these machines that are disparate to seamlessly integrate as one cohesive offering.

In FIG. 1, the individual machines are depicted, which are involved in the functions of the bank. This invention is the machine labeled BTC that performs the following functions. It communicates with the machines that perform specific functions with the bank, securely, high performance, and present to the customer a seamless interface to all the functions that the machine performs, listed in Table 1 and uses meta data and meta meta data to detect and mitigate, terrorism, and other illegal activities such as human trafficking and drugs.

Table 2 lists examples of existing machines and systems that perform some of those functions, but not in a secure or integrated way.

The BTC Machine integrates all these other machines seamlessly, securely, globally, with high performance.

Table 1 below describes all of the functions of the bank from a customer's point of view, that are enabled by FIG. 1 architecture:

TABLE 1
Bitcoin International Bank Trust Services

| Personal | Business | International | Commercial |
|---|---|---|---|
| Banking | Banking | Banking | Banking |
| Checking Account | Bitcoin Gift | International | Commercial |
| Free Bitcoin storage | Certificates and | Payments and | Lending of |
| eStatements | Traveler Checks | Money Transfers | Working Capital to |
| Free Bitcoin withdrawal | Lending | Bitcoin to raise | Small Businesses |
| Bitcoin Cash ATM | Credit and | funds overseas | Short Term Cash |
| (Genesis) | Financing | Credit and | Requirements |
| Secure Cold Storage | Bitcoin Fraud | Financing | Credit and |
| Insured | Protection | Bitcoin Fraud | Financing |
| Protected from Volatility | Strategies | Protection | Bitcoin Fraud |
| Account Transfer | Risk Analysis | Strategies | Protection |
| Wire Transfer | Line of Credit | Risk Analysis | Strategies |
| International currency | | Line of Credit | Risk Analysis |
| exchange | | | Line of Credit |
| Savings Accounts | | | |
| Accruing Interest | | | |
| Insured | | | |
| Protected from Volatility | | | |
| Account Transfer | | | |
| Wire Transfer | | | |
| Free Bitcoin Storage | | | |
| Certificate of Deposits | | | |
| Accruing Interest | | | |
| Insured | | | |
| Protected from Volatility | | | |
| Loans | | | |
| Low Interest | | | |
| Money quickly available | | | |
| Insured | | | |
| Investment | | | |
| Insured | | | |
| Bitcoin Macro Analytics | | | |
| Arbitrage | | | |
| Hedge Fund | | | |
| ETFs | | | |
| Index Funds | | | |
| Insurance | | | |
| Insured | | | |
| Captive Insurance | | | |
| Company | | | |
| Exchanges | | | |
| Insured | | | |
| Low Conversion Fee | | | |
| International Currency | | | |
| Conversion | | | |

Table 2 below contains a list of existing companies that provide some of these functions:

TABLE 2
Example Bitcoin Companies used for Bitcoin Bank Architecture:

| Companies | Websites | Role in Bank |
|---|---|---|
| Coinbase | https://www.coinbase.com/ | Bitcoin Storage |
| Coinsimple | https://coinsimple.com/ | Payment Processor |
| MexBt | https://mexbt.com/ | Exchanges |
| Coinsecure | https://coinsecure.in/ | Exchanges |
| Magnr | https://magnr.com/ | Bitcoin Storage, |
| | | Financial |
| Bitfinex | https://www.bitfinex.com/ | Financial |
| ANXPro | https://anxpro.com/ | Financial |
| BitBond | https://www.bitbond.com/ | Loans |
| BtcLend | https://btclend.org/ | Loans |
| Armory | https://bitcoinarmory.com/ | Cold Storage |
| | (Download Program from | |
| | this Site) | |
| Elliptic | https://www.elliptic.co/ | Cold Storage, |
| | | Insurance |
| Bitcoin Financial | http://bitcoinfinancialgroup.com/ | Insurance |
| Group | | |
| Vogogo | https://www.vogogo.com/ | Compliance/ |
| | | Insurance |
| Genesis Bitcoin | https://bitcoinatm.com/ | Bitcoin ATM |
| Atm | | |

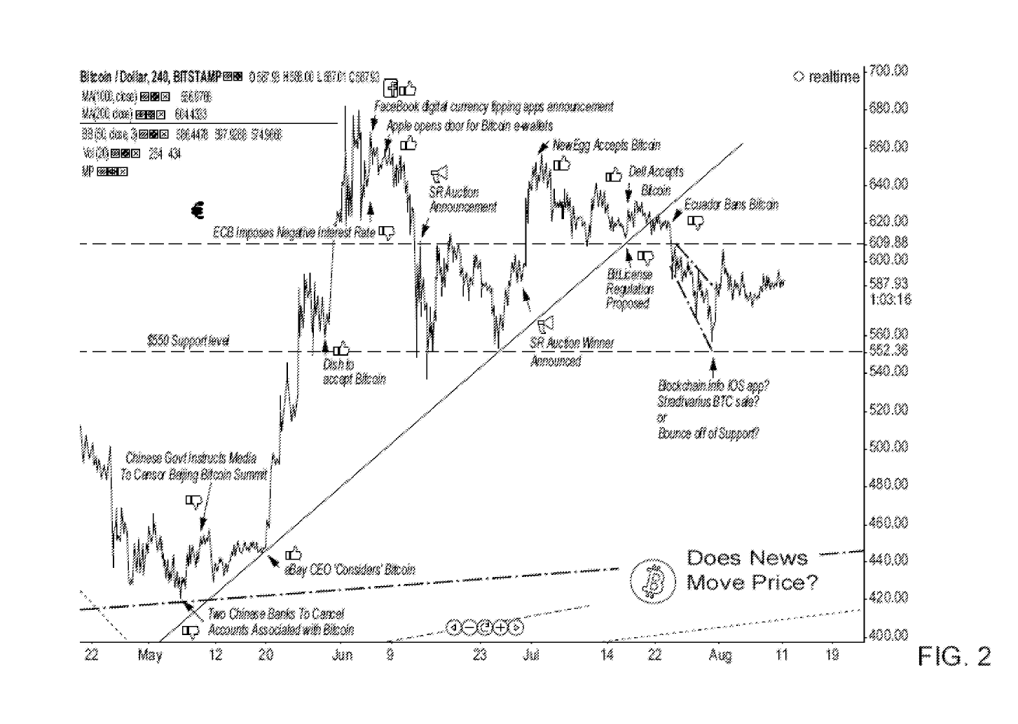

FIG. 2 refers to the volatility in the Bitcoin market. (Crytocoinnews.com, WHAT AFFECTS THE BITCOIN PRICE? (n.d.))

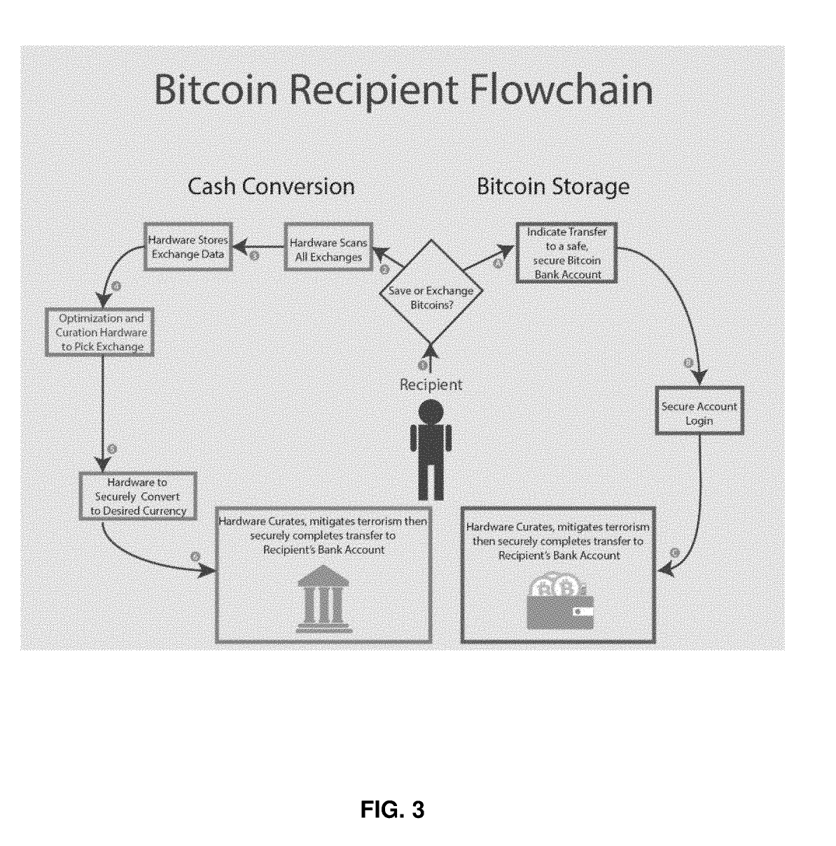

FIG. 3—Bitcoin Flowchain (Explaining Cash Conversion and Bitcoin Storage)

Step 1—Customer Receives or Purchases Bitcoins

Option 1—Cash Conversion

Step 2—Hardware Scans all Exchanges

Customer selects to exchange Bitcoin to a currency. Banks unique, and specially designed invented hardware scans information from exchanges to determine most favorable exchange for customer. Bank's hardware asks exchanges for the following information:
Exchange rate from Bitcoins to Currency
Fees
Total conversion amount
Conversion time

Step 3—Hardware Stores Exchange Data

Bank's unique, and specially designed invented hardware receives requested data from exchanges and stores data to later optimize best result for customer.

Step 4—Optimization and Curation

International Bitcoin Bank gathers all the information provided by exchanges and passes the information to the optimization hardware. The optimization hardware calculates variables through maximization formula to obtain optimum exchange rates. Hardware selects best result to create exchange for customer.

Step 6—Transfer to Recipient's Selected Bank Account

Unique, and specially designed invented hardware curates, verifies, and, after mitigating from terrorism, securely transfers customer's new currency into selected bank account.

Option 2—Bitcoin Storage

Step A—Customer Indicates Transfer to Online Bitcoin Account

Customer chooses to transfer Bitcoins to personal online Bitcoin account. These can be stored on their online bank account or on our secure hardware in cold storage.

Step B—Secure Account Login

Customer is prompted to securely log into account where they desire to transfer Bitcoins.

Step C—Transfer to Recipient's Bitcoin Account

Unique, and specially designed invented hardware curates, verifies, and, after mitigating from terrorism, securely transfers customer's Bitcoins to desired Bitcoin account.

Hedging Bitcoin Investment in Bank

The invention of the hedging hardware will be used to create the best solutions for maintaining or growing the value of a basket of investments that include Bitcoins. Where within that basket there are bitcoins and other elements. These elements in the baskets will be called the hedged elements. Bitcoins values fluctuate enormously (see FIG. 2). This hardware will best preserve the investment value made in Bitcoins. The investment value is the value of the bitcoins plus the hedge entities that will be preserved.

The process of hedging the Bitcoin investment is a two-step process. One to pick elements that behave inversely to the value of bitcoins taking into account meta data. Two, adding these elements to a basket. The percentage of each element that is added to the basket is determined by a formula using the meta data associated with each element. That meta data changes with time and hence the composition of the basket changes with time.

Step 1

Select from examples of the following sets of elements include:

1. Commodities

2. Currencies

3. Crypto-currencies

4. Mining Accessories

5. Traded Stocks

6. Government Bonds

7. Real Estate

8. Bonds

9. Certificate of Deposits

Example of meta data include:
T-Statistic of the correlation of the element of the time series valuation of Bitcoins
Other Meta Data Includes:
External events, such as the stability of the countries where the currencies are in
Future weather conditions
Likelihood of political disruptions
Terrorism
Etc. . . .

Equation 2 below explains how the hedging hardware will select the best neutral or inversely correlated elements.

Eᵢ(Max T Score)=r(B≈E1≈E2≈E3 Equation 2: EQUATION FOR PICKING ELEMENTS

Where:

r=regression

B=Bitcoin value

E=Value of element

Hence, we have now picked the elements and move on to Step 2

Step 2

Places in a basket the best performing elements for hedging Bitcoins. Where best is determined by a collection of percentages of each element. The meta data of each element which best optimized stability and inverse correlation to value of Bitcoins.

$$Element {Coefficient}_{j} = {\sum }_{i = 1}^{n} {Ew}_{i} {Ex}_{i} \qquad Equation 3$$

Where: Ex is specific element's meta data associated with specific i
Ew represents the specific element's weight given to that meta data associated with i
Element Coefficientⱼ is the element's numerical relation to weighted meta data

Examples of weighting would be on a scale of 1 to 10, the reliability of the news source, New York Times, would be weighted very high.

This hardware would use meta data (weightings to each of the meta data values, these then would be summed in a machine using regression analysis) to identify the best exchanges, including:
1. Social networking, Facebook, twitter, etc. to predict the volatility and directions of values of bitcoins
2. Forum of technical people
3. Forum of financial people
4. News Articles
5. Bitcoin data (Blockchain.info) e.g. total transaction fees collected, number of transactions
6. Google Searches
7. Total investments in bitcoin ventures
8. Comparing to commodities
9. Consumer prices, utilities, electricity
10. National GDP's around the world
11. Mining Accessories
12. Identify baskets and individual stock
13. Disposable Income
14. World unrest
15. Government Regulations
16. Laws that change
17. Characteristics of bitcoins, volume of trading, velocity, and quantity
18. Natural disasters
19. Number of companies recognizing bitcoins

$$Basket ( {Optimized}_{t} ) = U {\sum }_{i = 1}^{n} ( Element Coefficient * Element ) + B$$

Where:

B is the Bitcoin value

Basket is the collection of elements plus Bitcoins

Converting into Currencies

This invention is hardware to create the optimal value when converting Bitcoins into different currencies. Bitcoins values fluctuate enormously (FIG. 2). Our goal is to preserve the value of Bitcoins against most currencies in particular currency USD. Meta-data considered by the invented hardware when converting into currencies for customer will include:
1. Authenticated people doing the conversion
2. Authenticate bank for transaction
3. Using historical records of transactions
4. Endorsements
5. Rates of conversions and fees
6. Identify commodities, stocks to track the volatility of bitcoins
7. Identify use of data from social networking, Facebook, twitter, etc. to predict the volatility and directions of values of bitcoins
8. Forum of technical people
9. Forum of financial people
10. News Articles
11. Bitcoin data (Blockchain.info) e.g. total transaction fees collected, number of transactions
12. Google Searches
13. Total investments in bitcoin ventures
14. Comparing to commodities
15. Consumer prices, utilities, electricity
16. National GDP's around the world
17. Mining Accessories
18. Identify baskets and individual stock
19. Disposable Income
20. World unrest
21. Government Regulations
22. Laws that change
23. Characteristics of bitcoins, volume of trading, velocity, and quantity
24. Natural disasters
25. Number of companies recognizing bitcoins
26. Customer's Gender
27. Customer's Age
28. Past Transactions with Bitcoins
29. Customer's Religion
30. Customer's Background
31. Customer's Ethnicity

Mathematical Expression:

The process of optimization and conversion to USD can be possibly described in mathematical form from Equation 3 below

Let:

r_{Bu}=Exchange rate

c_{B}=Fixed cost to convert B into different currencies

x_{BU}=Amount of ‘Bitcoin’ (represented as B) exchanged for currency USD (represented as U)

y_{B}=Whether any of Bitcoin, B, is exchanged for other currencies

U_{B}=Cap on the total amount of Bitcoin that can be converted

Note that the amount of currency U we end up with after exchanging from B is

r_{BU}*X_{BU}

Ultimately, we want to end up with as much of currency U as possible, so our objective function is the amount of Bitcoin and any other currencies exchanged into currency U:

$$f = max {\sum }_{B = 1}^{U} {r}_{BU} {x}_{BU} - {\sum }_{B = 1}^{U} {c}_{B} {y}_{B} \\ such that \\ {\sum }_{U = 1}^{N} {x}_{BU} \leq {y}_{B} {u}_{B} ∀ B ∈ [ 1 , … , N ] \\ {x}_{BU} \geq 0 , ∀ B ∈ [ 1 , … , N - 1 ] , U ∈ [ 1 , … , N ] \\ {y}_{B} ∈ \{ 0 , 1 \} ∀ B ∈ [ 1 , … , N - 1 ] \qquad Equation 3$$

Security of Bitcoins

The Need

The need for a secure bitcoin bank is prominent. Currently, there is no bitcoin bank. The aggregation of services to form a bank will not only be highly innovative but will lead to further advancement in the bitcoin and banking community.

Mt. Gox, used to be one of the largest bitcoin exchanges in the world. Based out of Japan, Mt. Gox, was launched in July 2010, by 2013—handled 70% of all bitcoin transactions in the world and in 2014, Mt. Gox filed for bankruptcy and closed its website due to the disappearance (likely stolen), an amount of 850,000 bitcoins.

Flexcoin, one of the first bitcoin banks which was created in 2011, which allowed for a centralized location to store and access bitcoins from anywhere in the world. In March of 2014, they were attacked by a hacker who was able to withdraw bitcoins from accounts into his own private account. Over the three years that flexcoin was running, they repelled thousands of attacks but this led to the demise of their company.

Both of these banks went out of business because of security breaches where the bitcoin was stored. Bitcoin will be particularly attractive to hackers because it is money, stored electronically, is anonymous and international.

The security of bitcoins in the entire architecture is multi-faceted. Encryption of all data passed between customers and our invention, and all the entities the bank interfaces with, is secured with this invention. Partial bitcoin storage offline via cold storage. Cold storage will be provided through invented hardware that stores Bitcoins through multiple layers of encryption and physical protection. Unique personal wallet id generation will also be used to provide another layer of security. Bitcoins will be stored behind a firewall on servers which have never been connected to the internet to ensure security.

Security while using the bank's services is of outmost importance. That is why we created the hardware system which guarantees the security of payment processes for all customers. This hardware system would encrypt and secure any and all data transmission. Equation 2 below expresses how the machine will use weighted meta data to create alert.

$${alerts}_{j} = {\sum }_{i = 1}^{n} {w}_{i} {x}_{i} \qquad Equation 3$$

Where: x is meta data associated with i
w is the weight given to that meta data associated with i
alertsⱼ is the alert sent to the appropriate authority j

Examples of weighting would be on a scale of 1 to 10, the date, September 11, would be weighted very high. The meta data associated with a tip, if a tip was from a reliable informant, would be higher that an anonymous tip. This hardware would use meta data (weightings to each of the meta data values, these then would be summed in a machine using regression analysis) to combat the following types of security breaches with associated meta data.

Security within the Architecture

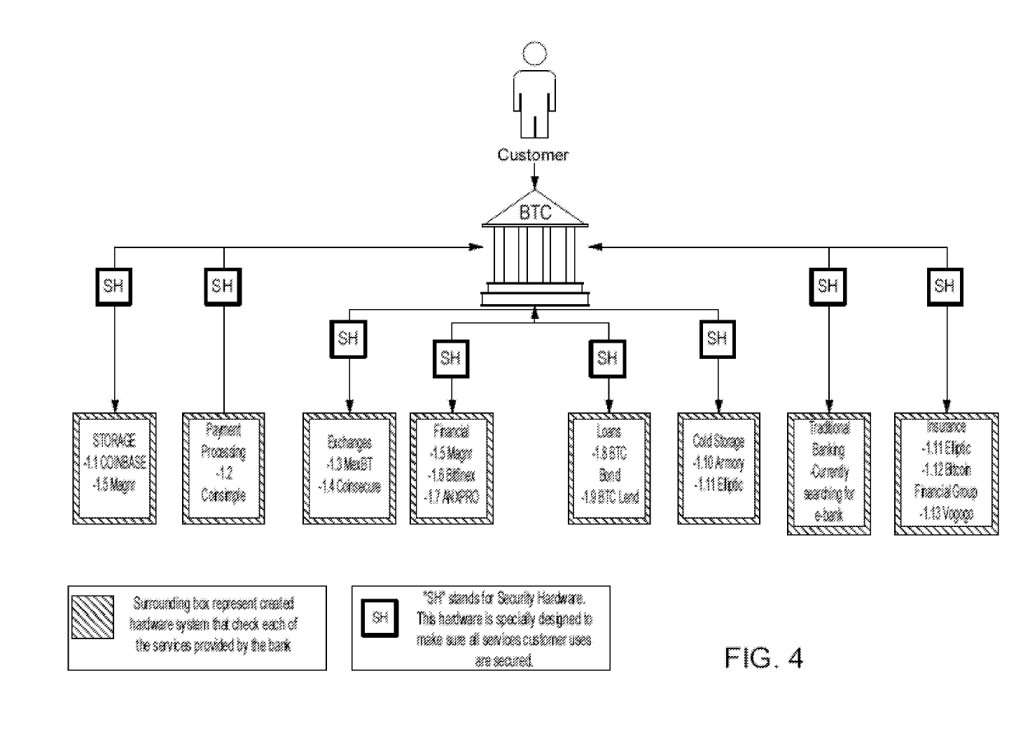

FIG. 4—Bitcoin Service Security

FIG. 4 above describes how our invented hardware would ensure that any and all transactions and services within the bank architecture are secure. Two specialized invented hardware will be used for these purposes. One of these machines will be used within each service to ensure that all processes the customer is making are legitimate, and authenticated. The second would ensure that any and all communication of the services is legitimate and authenticated. This would prevent any fraudulent activities from occurring.

There are three vulnerabilities to a bitcoin bank are hacking, denial of service, and spoofing. The uniquely invented hardware will take the following meta-data into account to prevent any of these events to occur:

Hacking

Meta-data retrieved by invented hardware to prevent hacking will include:
1. The DNS route that an individual customer takes in getting to the bank
2. Inconsistent I.P addresses
3. Location of the customer
4. The Delta of withdrawals
5. Identify commodities, stocks to track the volatility of bitcoins
6. Identify use of data from social networking, Facebook, twitter, etc. to predict the volatility and directions of values of bitcoins
7. Forum of technical people
8. Forum of financial people
9. News Articles
10. Bitcoin data (Blockchain.info) e.g. total transaction fees collected, number of transactions
11. Google Searches
12. Total investments in bitcoin ventures
13. Comparing to commodities
14. Consumer prices, utilities, electricity
15. National GDP's around the world
16. Mining Accessories
17. Identify baskets and individual stock
18. Disposable Income
19. World unrest
20. Government Regulations
21. Laws that change
22. Characteristics of bitcoins, volume of trading, velocity, and quantity
23. Natural disasters
24. Number of companies recognizing bitcoins
25. Customer's Gender
26. Customer's Age
27. Past Transactions with Bitcoins
28. Customer's Religion
29. Customer's Background
30. Customer's Ethnicity

Denial of Service

Meta-data retrieved by invented hardware to prevent Denial of Service will include:
1. The change in accesses
2. Identify commodities, stocks to track the volatility of bitcoins
3. Identify use of data from social networking, Facebook, twitter, etc. to predict the volatility and directions of values of bitcoins
4. Forum of technical people
5. Forum of financial people
6. News Articles
7. Bitcoin data (Blockchain.info) e.g. total transaction fees collected, number of transactions
8. Google Searches
9. Total investments in bitcoin ventures
10. Comparing to commodities
11. Consumer prices, utilities, electricity
12. National GDP's around the world
13. Mining Accessories
14. Identify baskets and individual stock
15. Disposable Income
16. World unrest
17. Government Regulations
18. Laws that change
19. Characteristics of bitcoins, volume of trading, velocity, and quantity
20. Natural disasters
21. Number of companies recognizing bitcoins
22. Customer's Gender
23. Customer's Age
24. Past Transactions with Bitcoins
25. Customer's Religion
26. Customer's Background
27. Customer's Ethnicity

Spoofing

Meta-data retrieved by invented hardware to prevent Spoofing will include:
1. The change of the route of the customer
2. Identify commodities, stocks to track the volatility of bitcoins
3. Identify use of data from social networking, Facebook, twitter, etc. to predict the volatility and directions of values of bitcoins
4. Forum of technical people
5. Forum of financial people
6. News Articles
7. Bitcoin data (Blockchain.info) e.g. total transaction fees collected, number of transactions
8. Google Searches
9. Total investments in bitcoin ventures
10. Comparing to commodities
11. Consumer prices, utilities, electricity
12. National GDP's around the world
13. Mining Accessories
14. Identify baskets and individual stock
15. Disposable Income
16. World unrest
17. Government Regulations
18. Laws that change
19. Characteristics of bitcoins, volume of trading, velocity, and quantity
20. Natural disasters
21. Number of companies recognizing bitcoins
22. Customer's Gender
23. Customer's Age
24. Past Transactions with Bitcoins
25. Customer's Religion
26. Customer's Background
27. Customer's Ethnicity

Storage

The bank would offer storage options for either or both online and offline storage for customers. The online storage would use enhanced, with our invented hardware, servers to securely store and keep track of all transactions. Offline storage would use secure and efficient hardware that would store Bitcoins for customers. Hardware has been invented in order to authenticate person which brings storage from online to offline or offline back online. This transaction will also require invented hardware to communicate between online and offline (or offline to online) storage when customer asks to do so.

Online Storage

Hardware either within or external to the server which is connected through a network.

Cold Storage

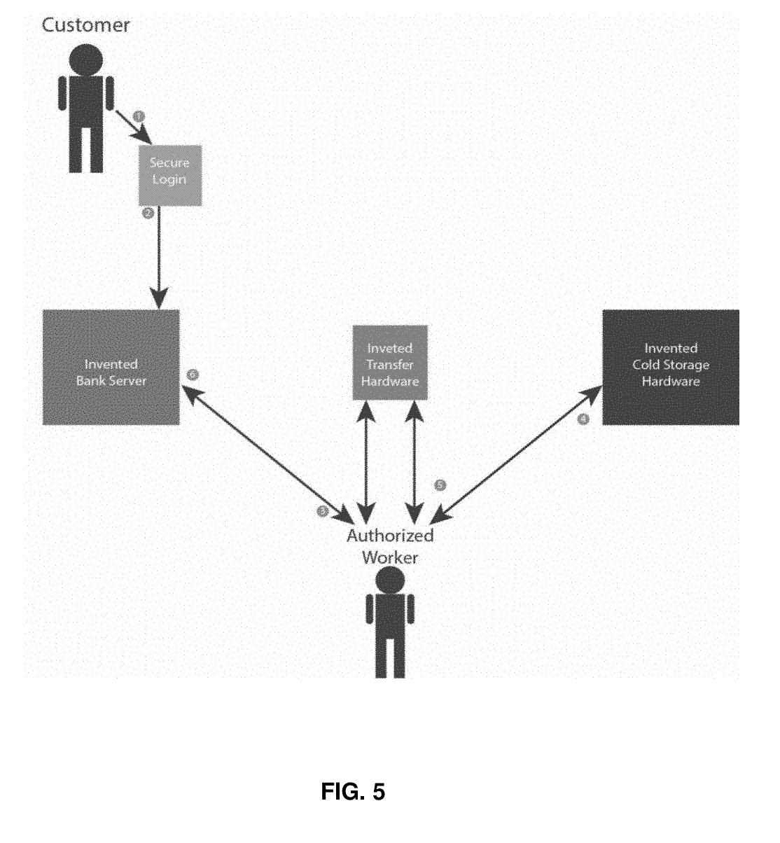

FIG. 5—Cold Storage Illustration

Step 1

Customer securely logs-in to bank account

Step 2

Customer selects to store Bitcoins in Cold Storage

Step 3

Authorized worker securely moves customer's Bitcoin data from Invented Bank Server using invented transfer hardware

Step 4

Authorized worker securely moves customer's Bitcoin data from invented hardware to invented cold storage hardware

Step 5

When customer requests to withdraw Bitcoins, authorized worker securely moves customer's Bitcoin data from invented cold storage hardware to invented hardware

Step 6

When customer requests to withdraw Bitcoins, authorized worker securely moves customer's Bitcoin data from invented hardware to invented bank server

Authorized Worker Security

The Authorized Worker, who is responsible for the authorization of the transfer of bitcoins from the invented bank server to the invented cold storage hardware using the inverted transfer hardware

Examples of possible but not limited to security requirements in place for the authorized worker:
1) Background Security Check
2) Security Clearance
3) Biometrics
4) Multi-Authenticated Security
5) Constant Monitoring of All Worker Actions

Arbitrage

The bank would utilize hardware that optimizes the value of the currencies from the organization we're buying Bitcoins from. This hardware would utilize data given to the machine from the different organization under the architecture in order, maximize returns, use current trends, and predict trends. Equation 4 below expresses how the machine will use weighted meta data to create alert.

$$best {exchange}_{j} = {\sum }_{i = 1}^{n} {w}_{i} {x}_{i} \qquad Equation 4$$

Where: x is meta data associated with i
w is the weight given to that meta data associated with i
alertsⱼ is the alert sent to the appropriate authority j

Examples of weighting would be on a scale of 1 to 10, the news source, New York Times, would be weighted very high. This hardware would use meta data (weightings to each of the meta data values, these then would be summed in a machine using regression analysis) to identify the best exchanges, including:
1. Identify commodities, stocks to track the volatility of bitcoins
2. Identify use of data from social networking, Facebook, twitter, etc. to predict the volatility and directions of values of bitcoins
3. Forum of technical people
4. Forum of financial people
5. News Articles
6. Bitcoin data (Blockchain.info) e.g. total transaction fees collected, number of transactions
7. Google Searches
8. Total investments in bitcoin ventures
9. Comparing to commodities
10. Consumer prices, utilities, electricity
11. National GDP's around the world
12. Mining Accessories
13. Identify baskets and individual stock
14. Disposable Income
15. World unrest
16. Government Regulations
17. Laws that change
18. Characteristics of bitcoins, volume of trading, velocity, and quantity
19. Natural disasters
20. Number of companies recognizing bitcoins
21. Customer's Gender
22. Customer's Age
23. Past Transactions with Bitcoins
24. Customer's Religion
25. Customer's Background
26. Customer's Ethnicity

Detection and Mitigation of Terrorism and Other Illegal Activities

There are opportunities for bad people to use these devices and networks for transferring money that would be used for terrorism. This invention uncaptured in a machine uses meta data and meta data on meta data, to detect (weightings to each of the meta data values, these then would be summed in a machine using regression analysis) the possibility and alert the appropriate authorities. Equation 5 below expresses the calculation that the machine would follow.

$${alerts}_{j} = {\sum }_{i = 1}^{n} {w}_{i} {x}_{i} \qquad Equation 5$$

Where: x is meta data associated with i
w is the weight given to that meta data associated with i
alertsⱼ is the alert sent to the appropriate authority j

Examples of weighting would be on a scale of 1 to 10, the date, September 11, would be weighted very high. The meta data associated with a tip, if a tip was from a reliable informant, would be higher that an anonymous tip. This hardware system would use meta data including:
1. The DNS route that an individual customer takes in getting to the bank
2. Inconsistent I.P addresses
3. Location of the customer
4. The Delta of withdrawals
5. Identify use of data from social networking, Facebook, twitter, etc. to predict the potential threats
6. Forum of technical people
7. Forum of financial people
8. News Articles
9. Google Searches of invented devices
10. Total money spent
11. Tips
12. National GDP's around the world
13. Disposable Income
14. World unrest
15. Government Regulations
16. Laws that change
17. Natural disasters
18. Customer's Gender
19. Customer's Age
20. Receiving financial institution's history
21. Receiving financial institution's location
22. Receiving financial institution's authenticity
23. Receiving financial institution's longevity
24. Receiving financial institution's ties to terrorist organizations
25. Receiving financial institution's ties to individuals
26. Receiver Age
27. Receiver Religion
28. Receiver Ethnicity
29. Receiver Gender
30. Past Transactions
31. Customer's Religion
32. Customer's Background
33. Customer's Ethnicity
34. Customer's Spending habits
35. Customer's Credit score
36. Amount of Purchases
37. Time of Year
38. Time of Purchases
39. Time of Transaction
40. Percentage of none completed transaction
41. Percentage of credit card denials
42. E-commerce hits
43. Volume Customers
44. The change of the route of the customer
45. Customer's Criminal Record
46. Customer's Background
47. Receiver Criminal Record
48. Receiver Background
49. Customer's Investments
50. Receiver Investment

Procuring Bitcoins

This invention includes hardware has been invented to create the best solutions for procuring Bitcoins. This invention seeks to find the best organization to purchase bitcoins from. Equation 6 below expresses the calculation that the machine would follow.

$$best {miner}_{j} = {\sum }_{i = 1}^{n} {w}_{i} {x}_{i} \qquad Equation 6$$

Where: x is meta data associated with i
w is the weight given to that meta data associated with i
best minerⱼ is the alert sent to the complete purchase j

Examples of weighting would be on a scale of 1 to 10, the date, September 11, would be weighted very high. The meta data associated with a tip, if a tip was from a reliable informant, would be higher that an anonymous tip. This hardware system would use meta data including:
1. Price
2. Reliability
3. Timing
4. Miner's longevity
5. Look for variances in prices
6. Authenticate by endorsements
7. Bitcoin volume
8. Country of origin
9. Past transactions with Bitcoins Authenticated people doing the conversion
10. Authenticate bank for transaction
11. Using historical records of transactions
12. Endorsements
13. Rates of conversions and fees
14. Identify commodities, stocks to track the volatility of bitcoins
15. Identify use of data from social networking, Facebook, twitter, etc. to predict the volatility and directions of values of bitcoins
16. Forum of technical people
17. Forum of financial people
18. News Articles
19. Bitcoin data (Blockchain.info) e.g. total transaction fees collected, number of transactions
20. Google Searches
21. Total investments in bitcoin ventures
22. Comparing to commodities
23. Consumer prices, utilities, electricity
24. National GDP's around the world
25. Mining Accessories
26. Identify baskets and individual stock
27. Disposable Income
28. World unrest
29. Government Regulations
30. Laws that change
31. Characteristics of bitcoins, volume of trading, velocity, and quantity
32. Natural disasters
33. Number of companies recognizing bitcoins

Implementation

To implement this Bank, we would use the infrastructure of different partners and locate them under the architecture we created for the bank. This would allow for the bank to provide multiple services to the client. The bank could add services easily since the architecture is designed to support additions. The hardware invented for different services will be integral to securing, mitigating from architecture, curating, optimizing exchanges, and transferring Bitcoins and different currencies within the bank's architecture.

### Example Implementation

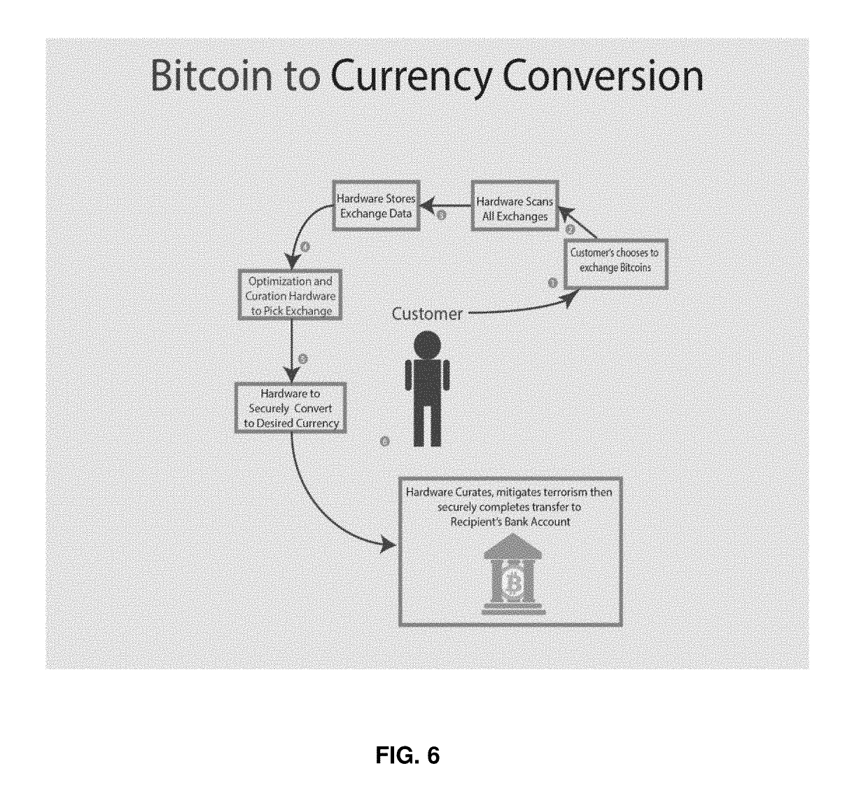

FIG. 6 shows bitcoin to currency conversion

Step 1—Customer Receives or Purchases Bitcoins

Step 2—Hardware Scans all Exchanges

Customer selects to exchange 1 Bitcoin to a USD. Banks unique, and specially designed invented hardware scans information from exchanges to determine most favorable exchange for customer. Bank's hardware asks exchanges for the following information:
Exchange rate for 1 Bitcoin to USD
Fees
Total conversion amount
Conversion time

Step 3—Hardware Stores Exchange Data

Bank's unique, and specially designed invented hardware receives requested data from exchanges and stores data to later optimize best result for customer.

Step 4—Optimization and Curation

International Bitcoin Bank gathers all the information provided by exchanges and passes the information to the optimization hardware. The optimization hardware calculates variables through maximization formula to obtain optimum exchange rates. Hardware selects best result to create exchange for customer.

Step 5—Secure Currency Conversion

Hardware securely completes conversion of Bitcoins to desired currency

Step 6—Transfer to Recipient's Selected Bank Account

Unique, and specially designed invented hardware curates, verifies, and, after mitigating from terrorism, securely transfers customer's new USD's into selected bank account.

### Definitions

1. As used herein, “Crypto-Currency” shall describe a digital currency on which encryptions are used to generate it.
2. As used herein, “Bitcoins” shall represent a crypto-currency which is bought, invested on, saved, and traded between individuals.
3. As used herein, “Bitcoin Wallet” shall mean an online account where Bitcoins are stored.
4. As used herein, “Multi-factor Authentication” shall describe the way the customer can successfully validated to proceed and indicate the authorization of an action. They would need to present multiple, separate, forms of authentication through credentials based on knowledge, possession, and biometrics.
5. As used herein, the term “meta-data” shall designate data about data. Examples include: descriptive date about data, time stamps, validity of the data, source of the data, etc.
6. As used herein, the term “Bitcoin Bank” shall describe an aggregation of financial and monetary services related to the Bitcoin currency, including: saving, checking account, investing, etc.
7. As used herein, the term “Social Media” shall represent online websites and applications that allow for social interaction between people. Example: Facebook, Twitter, Instagram, etc.
8. As used herein, the term “Blockchain” shall represent a public ledger of all Bitcoin transactions that have ever been executed.
9. As used herein, the term “Cold Storage” shall represent a secure, offline account where Bitcoins are stored.
10. As used herein, the term “Bitcoin Storage” shall represent the action of placing Bitcoin in a wallet or downloading them into Cold Storage.
11. As used herein, the term “Payment Processor” shall represent a company that handles bitcoin transactions from various channels such as credit cards and debit cards for merchants via banks.
12. As used herein, the term “Exchanges” shall refer to a physical location, website, or app that allows for the buying and selling of bitcoin and the conversion of bitcoins to various fiat currencies.
13. As used herein, the term “Bitcoin Data” or “Bitcoin Analytics” shall refer to data associated with bitcoins, for example transaction records, amounts, locations, etc.
14. As used herein, the term “Elements” shall refer to the possible investment options that can be used to even out the fluctuation in Bitcoin Value (Ex. US Dollar, Gold, Silver, etc.)
15. As used herein, the term “Sets of Elements” shall represent the possible groups of options that's could be used to hedge the fluctuation in Bitcoin Value (Ex. Currency, Commodities, etc.)
16. As used herein, the term “Basket” shall represent the collection of elements combined with Bitcoins that stabilized the value of the total basket (Ex. Currency, Commodities, etc.)

What is claimed is:

1. A method for procuring Bitcoins for a bank in a secure authenticated, efficient, and authenticated way, the method comprising authenticating with meta data and meta meta data associated with an exchange in mining.
